(19) United States
(12) Patent Application Publication
(10) Pub. No.: US 2018/0275330 A1
(43) Pub. Date: Sep. 27, 2018

(54) FIBER OPTIC PLANTER

(71) Applicant: National Tree Company, Cranford, NJ (US)

(72) Inventor: Michael M. McRae, Ormond Beach, FL (US)

(73) Assignee: National Tree Company, Cranford, NJ (US)

(21) Appl. No.: 15/468,778

(22) Filed: Mar. 24, 2017

(51) Int. Cl. F21V 8/00; F21S 9/03; H05B 37/02; F21V 29/76; F21V 31/00; F21V 23/00; A01G 9/02

(52) U.S. Cl. CPC G02B 6/0006; F21S 9/032; H05B 37/0272; F21Y 2115/10; F21V 31/005; F21V 23/003; A01G 9/02; F21V 29/76

(57) ABSTRACT

Apparatus and associated methods relate to a lighted planter formed from an emitter of light, a light source optically coupled with the emitter of light, an electrical power source electrically connected to the light source, and, an urn adapted to retain the emitter of light. In an illustrative example, the emitter of light may be an optic fiber bundle. The light source may be, for example, an LED (Light Emitting Diode) optically coupled with the optic fiber bundle. Various embodiments may provide programmable light sequences from a multi-colored light source configured by a wireless remote control. In some examples, the electrical power source may be a battery. Some embodiments may provide a photovoltaic cell adapted to charge the battery. Various examples may advantageously provide environmentally friendly decorative plant receptacles with adaptable configurations at reduced cost, for example, using solar power to illuminate custom-configured plant arrangements with user-programmable light sequences.

### TECHNICAL FIELD

Various embodiments relate generally to illuminated flowerpots.

### BACKGROUND

Flowerpots are plant containers. Plant containers retain flowers and other plants. Flowerpots retain plants within a receptacle enclosing a portion of the plant. For example, a flowerpot may retain the lower portion of a plant, allowing visibility to the plant's upper portion. A flowerpot may retain a natural or artificial plant. Plant containers may retain soil to support the growth of a natural plant. Some plant containers may be used to display items that are not natural or artificial plants. For example, a flowerpot may retain models or figures.

Users of flowerpots include individuals, businesses, and governments. For example, an individual may employ a flowerpot to locate a plant in or near their home. A landscaping business may, for example, improve the appearance of a property by installing a plant in a flowerpot at the property. Some municipal or other governments may enhance the visual appeal of public spaces at reduced cost with flowers or other plants in flowerpots. Some flowerpots may enable users to change a site's appearance without digging, by substituting plants in existing flowerpots. Displaying a plant in a flowerpot may enable a user to locate a plant at a site inconvenient for planting. For example, a flowerpot retaining soil may be used to locate a natural plant in a paved area, or where planting by digging into the ground is not allowed or impractical.

### SUMMARY

Apparatus and associated methods relate to a lighted planter formed from an emitter of light, a light source optically coupled with the emitter of light, an electrical power source electrically connected to the light source, and, an urn adapted to retain the emitter of light. In an illustrative example, the emitter of light may be an optic fiber bundle. The light source may be, for example, an LED (Light Emitting Diode) optically coupled with the optic fiber bundle. Various embodiments may provide programmable light sequences from a multi-colored light source configured by a wireless remote control. In some examples, the electrical power source may be a battery. Some embodiments may provide a photovoltaic cell adapted to charge the battery. Various examples may advantageously provide environmentally friendly decorative plant receptacles with adaptable configurations at reduced cost, for example, using solar power to illuminate custom-configured plant arrangements with user-programmable light sequences.

Various embodiments may achieve one or more advantages. For example, some embodiments may improve the visual appeal of a user's home. This facilitation may be a result of reducing the effort required to customize plant arrangements to the user's changing landscape design. In some embodiments, plants may be visible in dark areas, or even at night. Such nighttime visibility of plants may be a result of illuminating flowerpots with visually appealing optic fiber bundles. Some embodiments may provide growing natural plants with illuminated receptacles safe for watering. Such watering-safe illuminated plant receptacles may improve a user's landscaping options by providing an illuminated receptacle with water-tight protection of the electrical illumination components. For example, a user may be able to water a natural growing plant located in an embodiment fiber optic planter, avoiding electrical shock or damage, based on the water-tight plant receptacle.

In some embodiments, the illuminated appearance of plants may be varied automatically. This facilitation may be a result of a controller configured to display pre-programmed or user-customized plant illumination sequences. Some embodiments may reduce a user's effort to manage light sequences in large displays of many fiber optic planters. Such large display management efficiency may be a result of activating and controlling plant illumination sequences with a wireless remote control adapted to address many fiber optic planter illumination controllers. In some embodiments, the environmental impact of illuminated planter displays may be reduced. This facilitation may be a result of the use of solar energy to charge the fiber optic planter battery.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts a user installing a plant in an exemplary lighted planter formed from an emitter of light, a light source optically coupled with the emitter of light, an electrical power source electrically connected to the light source, and an urn adapted to retain the emitter of light.

FIG. 2 depicts a structural view of an exemplary fiber optic planter.

FIG. 3 depicts a side view of an exemplary fiber optic planter configured with a wireless remote control.

FIG. 4 depicts a structural view of an exemplary fiber optic planter having an alternative light source coupling.

FIG. 5 depicts an exemplary fiber optic planter light source.

Like reference symbols in the various drawings indicate like elements.

### DETAILED DESCRIPTION OF ILLUSTRATIVE EMBODIMENTS

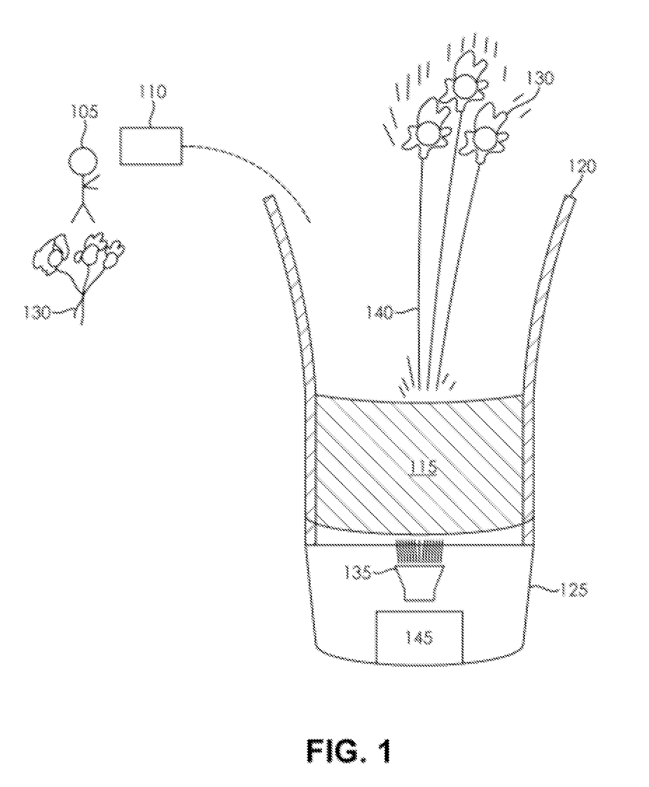

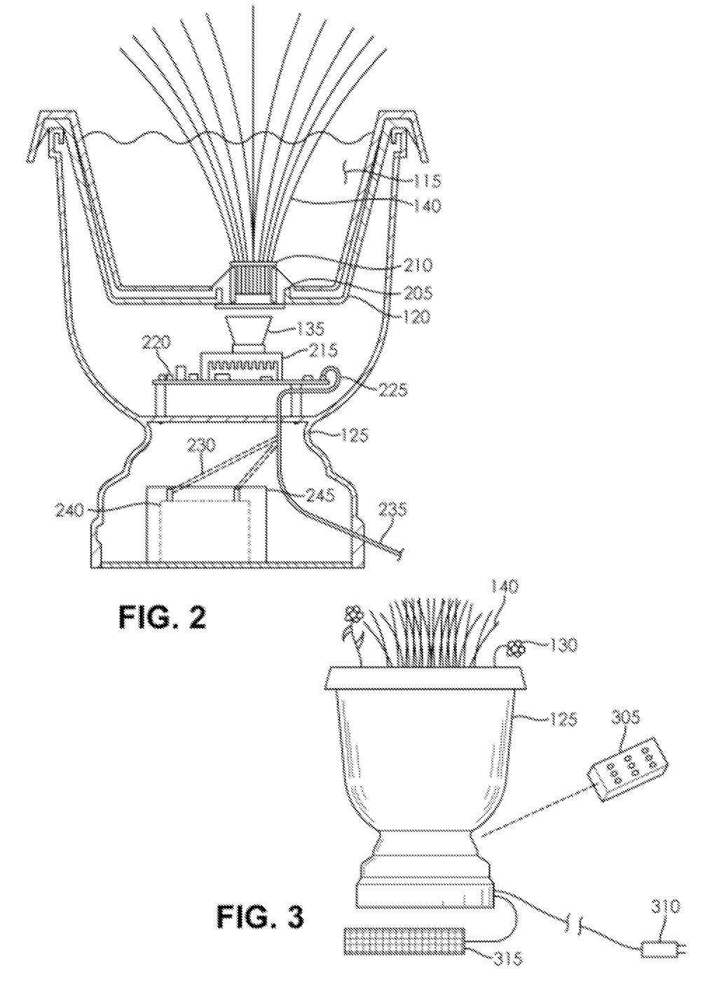

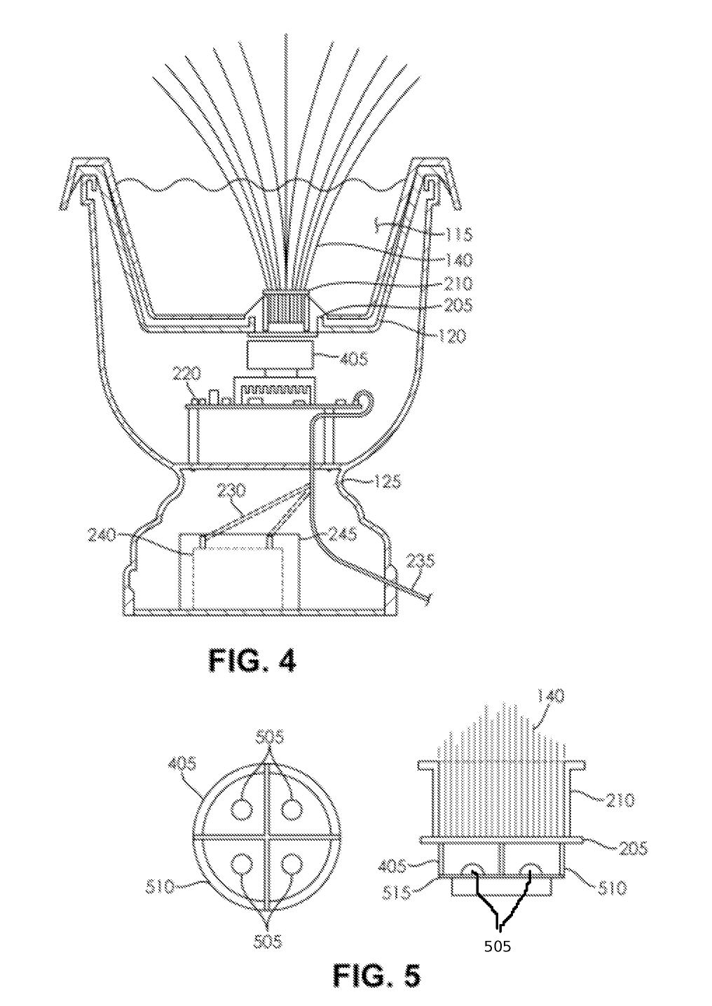

To aid understanding, this document is organized as follows. First, use of an exemplary lighted planter is briefly introduced with reference to FIG. 1. Second, with reference to FIG. 2, the discussion turns to exemplary embodiments that illustrate the construction of an exemplary fiber optic planter. Specifically, a fiber optic planter formed from an emitter of light, a light source coupled with the fiber optic emitter of light, an electrical power source electrically connected to the light source, and, an urn adapted to retain the emitter of light, is described. Then, with reference to FIG. 3, an example of a fiber optic planter configured with a wireless remote control is described. Next, with reference to FIG. 4, an exemplary fiber optic planter with an alternative light source coupling is disclosed. Finally, with reference to FIG. 5, an exemplary fiber optic planter light source is presented.

FIG. 1 depicts a user installing a plant in an exemplary lighted planter formed from an emitter of light, a light source optically coupled with the emitter of light, an electrical power source electrically connected to the light source, and an urn adapted to retain the emitter of light. In FIG. 1, a user 105 deposits soil 115, from a bag 110, into a planter insert 120 of an urn 125. In some embodiments, the planter insert 120 may be a substantially fluid-tight planter insert. In various examples, the planter insert 120 may be a semi-porous planter insert. Plant 130 may be illuminated by the light source 135 optically coupled with the optic fiber bundle 140. The optic fiber bundle 140 protrudes above the level of the soil 115. The light source 135 may be electrically connected to the electrical module 145. The light source 135 may be a multi-LED bulb. In an illustrative example, the electrical module 145 may include a controller adapted to activate the light source 135 to emit lighting or color sequences. In some embodiments, the controller may include a wireless interface adapted to communicatively and operably couple the controller with a wireless remote control to program light source 135 activation sequences. In various implementations, the electrical module 145 may include an electrical power source. In some designs, the electrical power source may be a battery. In various implementations, the electrical power source may include a photovoltaic cell adapted to charge the battery.

FIG. 2 depicts a structural view of an exemplary fiber optic planter. In FIG. 2, fluid-tight lens 205 optically couples the light source 135 to illuminate the fiber optic bundle 140. The light source 135 may be disposed within the urn 125 with sufficient spacing from the planter insert 120 to illuminate the base of the urn 125. In some examples, the urn 125 may be substantially opaque to the light emitted by the light source 135. In various embodiments, the urn 125 may be substantially translucent to the light emitted by the light source 135. The fiber optic base 210 may retain the fiber optic bundle 140 within the planter insert 120. The heat sink 215 may be mechanically and thermally coupled with the light source 135. The heat sink 215 may be mechanically and thermally coupled with the control circuit 220. The light source 135 may be electrically and operably connected with the control circuit 220 by leads 225. The battery leads 230 and power leads 235 may electrically connect the battery 240 to the controller circuit 220. The battery 240 may be retained within the battery holder 245.

FIG. 3 depicts a side view of an exemplary fiber optic planter configured with a wireless remote control. In FIG. 3, a wireless remote control 305 is operably and communicatively coupled with a controller circuit 220 within the urn 125. The wireless remote control may be adapted to activate the light source 135 to emit lighting or color sequences via a fiber optic bundle 140.The power adapter 310 may convert alternating current to direct current to illuminate the light source. A photovoltaic cell 315 may be electrically connected with and adapted to charge the battery 240.

FIG. 4 depicts a structural view of an exemplary fiber optic planter having an alternative light source coupling. In FIG. 4, the multi-bulb multi-LED bulb 405 is optically coupled by fluid-tight lens 205 to illuminate the fiber optic bundle 140. The multi-bulb multi-LED bulb 405 may be directly connected with the planter insert 120 via a fiber optic base 210.

FIG. 5 depicts an exemplary fiber optic planter light source. In FIG. 5, a multi-bulb multi-LED bulb 405 light source is depicted having four multi-LED bulbs 505 retained by a shield separator 510. The multi-bulb multi-LED bulb 405 may be mechanically supported by a holder 515. The fiber optic bundle 140 may be optically coupled with a multi-bulb multi-LED bulb 405 via the fluid-tight lens 205. The fiber optic bundle 140 may be retained by a fiber optic base 210.

Although various embodiments have been described with reference to the Figures, other embodiments are possible. A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A lighted planter comprising:
an emitter of light;
a light source optically coupled with the emitter of light;
an electrical power source electrically connected to the light source; and, an urn adapted to retain the emitter of light.

2. The lighted planter of claim 1, wherein the emitter of light further comprises optical fiber.

3. The lighted planter of claim 1, wherein the light source further comprises a multi-LED bulb.

4. The lighted planter of claim 1, wherein the lighted planter further comprises a substantially fluid-tight insert retained within the urn.

5. The lighted planter of claim 1, wherein the lighted planter further comprises: a fiber optic collar coupled with the light source; and, a substantially fluid-tight socket retaining the fiber optic collar.

6. The lighted planter of claim 1, wherein the lighted planter further comprises a light source adapted to selectively emit multiple light colors.

7. A fiber optic planter comprising:
a fiber optic emitter of light;
a light source coupled with the fiber optic emitter of light;
an electrical power source electrically connected to the light source; and, an urn adapted to retain the emitter of light.

8. The fiber optic planter of claim 7, wherein the light source further comprises a multi-LED bulb.

9. The fiber optic planter of claim 7, wherein the fiber optic planter further comprises a substantially water-tight planter insert retained within the urn.

10. The fiber optic planter of claim 7, wherein the fiber optic planter further comprises a substantially fluid-tight lens optically coupled with the light source.

11. The fiber optic planter of claim 7, wherein the fiber optic planter further comprises a controller adapted to configure the light source to selectively emit multiple light colors.

12. The fiber optic planter of claim 7, wherein the electrical power source further comprises a battery.

13. The fiber optic planter of claim 12, wherein the electrical power source further comprises a photovoltaic cell adapted to charge the battery.

14. A fiber optic planter comprising:
a fiber optic emitter of light;
a multi-color, multi-LED bulb optically coupled with the fiber optic emitter of light;
an electrical power source electrically connected to the multi-LED bulb;
an urn;
a substantially water-tight planter insert disposed within the urn; and,
an aperture in the planter insert adapted to visibly retain the fiber optic emitter of light within the urn.

15. The fiber optic planter of claim 14, wherein the fiber optic planter further comprises: a fiber optic collar optically coupled with the multi-LED bulb; and, a substantially fluid-tight socket retaining the fiber optic collar within the planter insert.

16. The fiber optic planter of claim 14, wherein the electrical power source further comprises a battery.

17. The fiber optic planter of claim 14, wherein the electrical power source further comprises a photovoltaic cell adapted to charge the battery.

18. The fiber optic planter of claim 14, wherein the fiber optic planter further comprises a controller adapted to configure the multi-color, multi-LED bulb to selectively emit multiple light colors.

19. The fiber optic planter of claim 18, wherein the controller further comprises an external control interface operably coupled with the controller and adapted to configure the controller with color selection, color patterns, light variations, or user-defined color sequences programmed into the controller via the external control interface.

20. The fiber optic planter of claim 19, wherein the external control interface is wireless.
